(19) United States
(12) Patent Application Publication
(10) Pub. No.: US 2026/0197146 A1
(43) Pub. Date: Jul. 9, 2026

(54) METHODS AND APPARATUSES FOR SYNCHRONIZATION SIGNAL BLOCK-LESS SECONDARY CELL OPERATIONS IN MOBILE COMMUNICATIONS

(71) Applicant: MEDIATEK INC., Hsinchu City (TW)

(72) Inventor: Hsuan-Li LIN, Hsinchu City (TW)

(73) Assignee: MEDIATEK INC., Hsinchu City (TW)

(21) Appl. No.: 19/474,653

(22) PCT Filed: Oct. 30, 2024
(86) PCT No.: PCT/CN2024/128546

§ 371 Date: Oct. 10, 2025

Related U.S. Application Data
(60) Provisional application No. 63/595,777, filed on Nov. 3, 2023.

(51) Int. Cl. H04L 5/00

(52) U.S. Cl. CPC H04L 5/0098

(57) ABSTRACT

Various solutions for synchronization signal block (SSB)-less secondary cell (SCell) operations in carrier aggregation (CA) are described. An apparatus may receive an SCell configuration from a primary cell (PCell). The SCell configuration may indicate an SCell operating without an SSB. The apparatus may also receive a signaling from the PCell. The signaling may indicate an activation of the first SCell. Then, the apparatus may determine a reference cell to provide a timing reference and an automatic gain control (AGC) source for the first SCell.

### CROSS REFERENCE TO RELATED PATENT APPLICATION(S)

The present disclosure is part of a non-provisional application claiming the priority benefit of U.S. Patent Application No. 63/595,777, filed 3 Nov. 2023, the content of which herein being incorporated by reference in its entirety.

### TECHNICAL FIELD

The present disclosure is generally related to mobile communications and, more particularly, to synchronization signal block (SSB)-less secondary cell (SCell) operations in mobile communications.

### BACKGROUND

Unless otherwise indicated herein, approaches described in this section are not prior art to the claims listed below and are not admitted as prior art by inclusion in this section.

In 4^{th} generation (4G) Long-Term Evolution (LTE) or 5^{th} generation (5G) New Radio (NR), multi-link operation is supported to increase system capacity and transmission efficiency of the communication systems. Multi-link operation can be implemented by carrier aggregation (CA) or dual connectivity (DC), where additional links are used to increase the amount of data that can be transferred to and from the user equipment (UE). The UE can be configured with more than one radio links (e.g., component carriers (CCs)) and can connect to more than one base station (BS) (e.g., serving cells). Under the CA framework of 5G NR, one CC is associated with one cell and each cell broadcasts its SSB (i.e., synchronization/physical broadcast channel (PBCH) block) to facilitate initial cell discovery and synchronization for the UE. To reduce the SSB overhead and improve network energy saving, in 3^{rd} Generation Partnership Project (3GPP) Release 15, the concept of SSB-less SCell is introduced which allows no SSB transmission on the target SCell, but it is limited to the scenarios of frequency range 1 (FR1) or frequency range 2 (FR2) intra-band contiguous carrier aggregation (CCA) with co-located BSs.

Later, in 3GPP Release 18, it is envisioned to extend the concept of SSB-less SCell to the scenarios of FRI inter-band CA with co-located BSs. However, without any SSB of the target SCell (i.e., the SSB-less SCell), it will be difficult for the UE to determine the timing of the SSB-less SCell and the power gain control for the SSB-less SCell during the inter-band CA operations. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to SSB-less SCell operations in mobile communications. It is believed that the above-described issue would be avoided or otherwise alleviated by implementing one or more of the proposed schemes described herein.

In one aspect, a method may involve an apparatus receiving an SCell configuration from a primary cell (PCell), wherein the SCell configuration indicates a first SCell operating without an SSB. The method may also involve the apparatus receiving a signaling from the PCell, wherein the signaling indicates an activation of the first SCell. The method may further involve the apparatus determining a reference cell to provide a timing reference and an automatic gain control (AGC) source for the first SCell.

In one aspect, an apparatus may comprise a transceiver which, during operation, wirelessly communicates with a PCell and one or more SCells. The apparatus may also comprise a processor communicatively coupled to the transceiver. The processor, during operation, may perform operations comprising receiving, via the transceiver, an SCell configuration from the PCell, wherein the SCell configuration indicates a first SCell operating without an SSB. The processor may also perform operations comprising receiving, via the transceiver, a signaling from the PCell, wherein the signaling indicates an activation of the first SCell. The processor may further perform operations comprising determining a reference cell to provide a timing reference and an AGC source for the first SCell.

In one aspect, a method may involve a network node (that forms a PCell) transmitting an SCell configuration to an apparatus, wherein the SCell configuration indicates a first SCell operating without an SSB and comprises a reference cell indicator indicating a reference cell for the first SCell. The method may also involve the apparatus transmitting a signaling to the apparatus, wherein the signaling indicates an activation of the first SCell.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of SSB-less SCell operations in accordance with an implementation of the present disclosure.

FIG. 3 is a diagram depicting an example scenario of a reference cell for an SSB-less SCell in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to SSB-less SCell operations in mobile communications. According to the present disclosure, a number of possible solutions may be implemented separately or jointly. That is, although these possible solutions may be described below separately, two or more of these possible solutions may be implemented in one combination or another.

In 3GPP Release 18, it is envisioned to extend the concept of SSB-less SCell to the scenarios of (FR1) inter-band CA with co-located BSs. Without the SSB of the target SCell (i.e., the SSB-less SCell), the UE may need a reference (e.g., a reference cell) to determine the timing of the SSB-less SCell and the power gain control for the SSB-less SCell during the inter-band CA operations. However, details regarding the SSB-less SCell operations in inter-band CA have not been fully discussed and some problems need to be solved. For example, one of the problems relate to how to select a reference cell for the inter-band SSB-less SCell. Another problem relates to how to select a reference SSB of the reference cell as the baseline for timing and power gain control with respect to the SSB-less SCell.

In view of the above, the present disclosure proposes a number of schemes pertaining to SSB-less SCell operations in mobile communications, aiming to solve the above-described problems. Under the first proposed scheme of the present disclosure, the reference cell for the inter-band SSB-less SCell may be determined by an explicit signaling indication (e.g., a reference cell indicator carried in a radio resource control (RRC) message) from the network side or by a certain assumption (e.g., assumed to be the quasi-colocation (QCL)-typeC source cell) at the UE side. The reference cell may be a PCell, an (activated) primary secondary cell group (SCG) cell (PSCell), or an activated SCell in the same timing alignment group (TAG) as the SSB-less SCell. For instance, the activated SCell may be any SCell within the same TAG as the SSB-less SCell, or may be the SCell with the smallest SCell ID, or may be the SCell with the latest received physical downlink shared channel (PDSCH) and the latest monitored control resource set (CORESET) in the active bandwidth part (BWP), or may be the SCell configured in the QCL information or transmission configuration indication (TCI) information for the SSB-less SCell (i.e. The QCL source cell). Under the second proposed scheme of the present disclosure, the reference SSB of the reference cell may be determined by the QCL/TCI information of the SSB-less SCell. For instance, the reference SSB may be the SSB that is QCLed to/with a reference signal (RS) of the SSB-less SCell, or may be the SSB associated to/with the activated TCI state (e.g., the SSB contained by the TCI state in the activated TCI state list, or the SSB QCLed to/with the TCI state in the activated TCI state list), or may be the SSB indicated in the TCI information in the SCell configuration (e.g., a serving cell configuration or an SCell addition configuration), or may be the SSB/TCI provided by the TCI information, or may be the SSB that has been used as radio link monitoring (RLM)-RS or beam failure detection (BFD)-RS of the reference cell, or may be the SSB that has been used as RLM-RS or BFD-RS of a cell within the same TAG as the SSB-less SCell. Accordingly, by applying the schemes of the present disclosure, the SSB-less SCell operations (in inter-band CA) may be realized to improve network/UE energy saving.

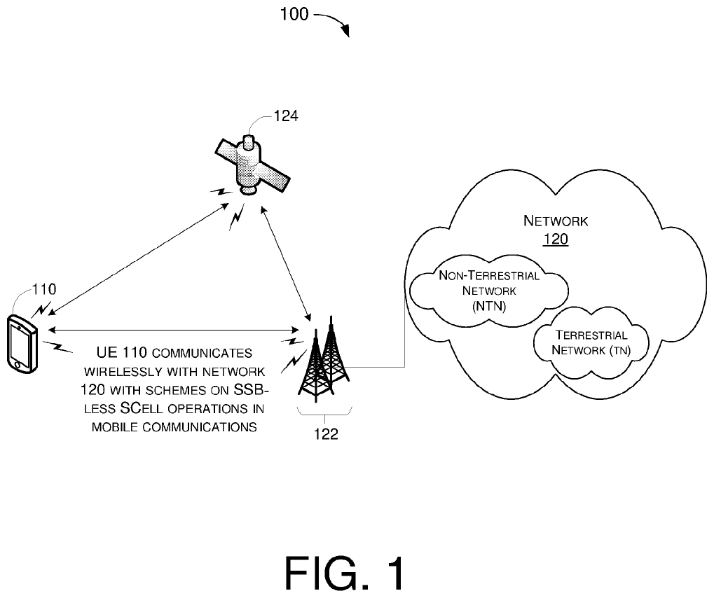

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including a non-terrestrial network (NTN) and a terrestrial network (TN)) via terrestrial network node(s) 122 (e.g., an evolved Node-B (eNB), a Next Generation Node-B (gNB), a transmission/reception point (TRP), or a gateway) and/or a non-terrestrial network node 124 (e.g., a satellite). For example, the terrestrial network node(s) 122 and/or the non-terrestrial network node 124 may form one or more NTN/TN serving cells for wireless communication with the UE 110. In some implementations, the terrestrial network node(s) 122 may include at least a master gNB (MgNB) and a secondary gNB (SgNB) for CA/DC operations. The MgNB and the SgNB may be co-located, and each of the MgNB and the SgNB may form one or more serving cells, where the cells under control of the MgNB comprise a master cell group (MCG) and the cells under control of the SgNB comprise a secondary cell group (SCG). In such communication environment, the UE 110, the network 120, and the terrestrial network node(s) 122 and/or the non-terrestrial network node 124 may implement various schemes pertaining to SSB-less SCell operations (in inter-band CA) in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

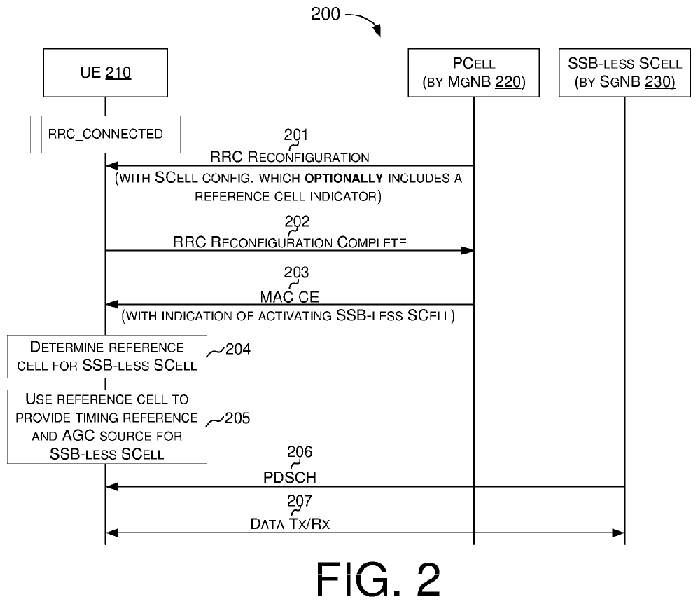

FIG. 2 illustrates an example scenario 200 of SSB-less SCell operations in accordance with an implementation of the present disclosure. Scenario 200 involves a UE 210 operating in RRC_CONNECTED mode to wirelessly communicate with at least a PCell formed by an MgNB 220 and an SSB-less SCell formed by an SgNB 230. In one example, the MgNB 220 and the SgNB 230 are co-located, and the PCell and the SCell are operating in different frequency bands. In step 201, the UE 210 receives an RRC Reconfiguration message including an SCell configuration of the SSB-less SCell from the PCell, wherein the SCell configuration may optionally include a reference cell indicator (e.g., a new parameter “referenceCell-r18”). For instance, the UE 210 may identify an SCell as SSB-less SCell if the parameter “absoluteFrequencySSB” (i.e., the SSB configuration) is not configured in the “FrequencyInfoDL” information element (IE) of the SCell configuration of this SCell. In step 202, the UE 210 transmits an RRC Reconfiguration Complete message to the PCell to complete the RRC reconfiguration procedure.

In step 203, the UE 210 receives a medium access control (MAC) control signaling (e.g., a MAC control element (CE)) from the PCell. Specifically, the MAC CE indicates an activation of the SSB-less SCell. For instance, the logical channel ID (LCID) of the MAC CE may indicate SCell Activation/Deactivation, and the data content (e.g., 1 octet or 4 octets) of the MAC CE may indicate which SCell to activate.

In step 204, the UE 210 determines the reference cell for the SSB-less SCell. In one example, if a reference cell indicator (e.g., new parameter “referenceCell-r18”) is configured in the SCell configuration of the SSB-less SCell, the UE 210 may select the reference cell based on the reference cell indicator. For instance, the parameter “referenceCell-r18” may include a serving cell index, and the serving cell with this index may be selected as the reference cell. The reference cell may be the PCell, an (activated) PSCell, or an activated SCell in the same TAG as the SSB-less SCell. Alternatively, if the reference cell indicator is not configured in the SCell configuration of the SSB-less SCell, the reference serving cell may be assumed to be the QCL-typeC source cell, i.e., the SCell configured in the QCL/TCI information for the SSB-less SCell. In step 205, the UE 210 uses the reference cell as the baseline to provide the timing reference and the AGC source for the SSB-less SCell. In one example, based on the reference cell (e.g., the SSB reception on the reference cell), the UE 210 may determine a rough estimation of the timing and power gain control for the SSB-less SCell. For instance, the timing used for the SSB reception on the reference cell may be directly applied to the SSB-less SCell operations, and the power gain control used for the SSB reception on the reference cell may serve as a baseline for the SSB-less SCell operations (e.g., if the SSB-less SCell is operating in a higher frequency carrier (e.g., PCell: 700 MHz, SSB-less SCell: 1.4 GHz), then the power used for the SSB-less SCell can be 6 dB (as free space) plus the power used for PCell).

In step 206, the UE 210 receives a PDSCH signal (e.g., a tracking reference signal (TRS), a demodulation reference signal (DMRS), or a channel state information-reference signal (CSI-RS)) from the SSB-less SCell. In step 207, the UE 210 performs a data transmission or reception to or from the SSB-less SCell based on the PDSCH signal. In one example, based on the PDSCH signal (e.g., the reception of the PDSCH signal), the UE 210 may determine a fine estimation of the timing and power gain control for the SSB-less SCell.

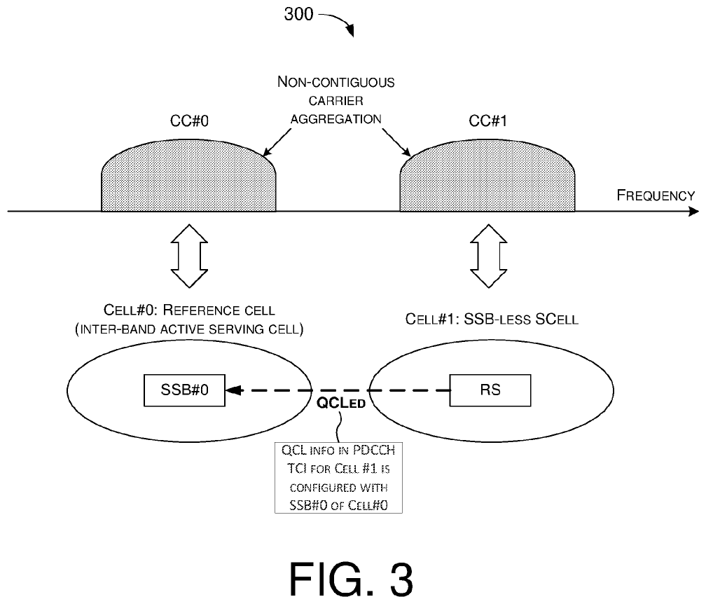

FIG. 3 illustrates an example scenario 300 of a reference cell for an SSB-less SCell in accordance with an implementation of the present disclosure. As shown in FIG. 3, two serving cells operating in different frequency bands (e.g., separate/non-contiguous CCs) are involved in CA operations, where cell #0 is the reference cell and cell #1 is the SSB-less SCell. It may be determined that the RS (or a UE-specific channel, PDSCH, PUSCH, DMRS, CSI-RS, or TRS) of the SSB-less SCell is QCLed to/with the SSB #0 of the reference cell, due to that the QCL information in the physical downlink control channel (PDCCH) TCI information for the SSB-less SCell is configured with SSB #0 of the reference cell. For instance, the QCL information may indicate the serving cell index of the reference cell and the SSB index of the reference SSB.

### Illustrative Implementations

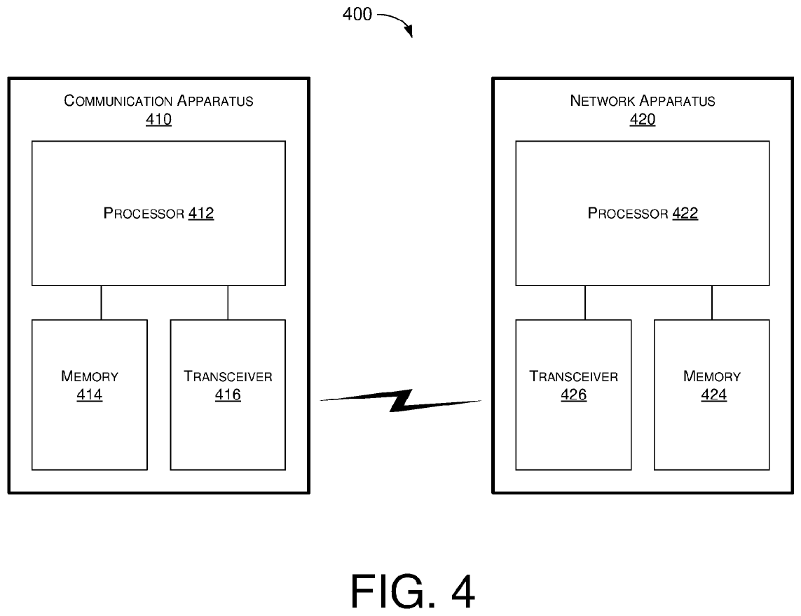

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to SSB-less SCell operations in mobile communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 410 may also be a part of a machine type apparatus, which may be an IoT, NB-IoT, or IIoT UE such as an immobile or a stationary apparatus, a home apparatus, a roadside unit (RSU), a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a BS, a small cell, a satellite, a router, or a gateway. For instance, network apparatus 420 may be implemented in an eNB in an LTE, LTE-Advanced or LTE-Advanced Pro network, or implemented in a gNB or TRP in a 5G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks, including SSB-less SCell operations, in a device (e.g., as represented by communication apparatus 410) and a network node (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of UEs and/or wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, a description of capabilities of communication apparatus 410, as a UE, and network apparatus 420, as a network node (e.g., BS), is provided below with processes 500 and 600.

### Illustrative Processes

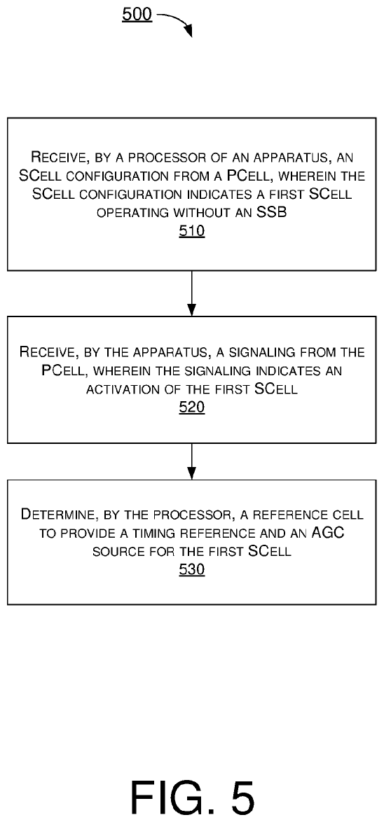

FIG. 5 illustrates an example process 500 in accordance with an implementation of the present disclosure. Process 500 may be an example implementation of above scenarios/schemes, whether partially or completely, with respect to SSB-less SCell operations in mobile communications. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by or in communication apparatus 410 or any suitable UE or machine type devices. Solely for illustrative purposes and without limitation, process 500 is described below in the context of communication apparatus 410, as a UE. Process 500 may begin at block 510.

At block 510, process 500 may involve processor 412 of communication apparatus 410 receiving, via transceiver 416, an SCell configuration from a PCell, wherein the SCell configuration indicates a first SCell operating without an SSB. Process 500 may proceed from block 510 to block 520.

At block 520, process 500 may involve processor 412 receiving, via transceiver 416, a signaling from the PCell, wherein the signaling indicates an activation of the first SCell. Process 500 may proceed from block 520 to block 530.

At block 530, process 500 may involve processor 412 determining a reference cell to provide a timing reference and an AGC source for the first SCell.

In some implementations, the reference cell may include the PCell, a PSCell, or a second SCell, wherein the PSCell and the second SCell are activated.

In some implementations, the first SCell and the second SCell may be configured in a same TAG.

In some implementations, the SCell configuration may include QCL information of an RS of the first SCell, and the QCL information may indicate that the RS of the first SCell is QCLed with an SSB of the second SCell.

In some implementations, the SCell configuration may include a reference cell indicator, and the determining of the reference cell may be performed based on the reference cell indicator.

In some implementations, the determining of the reference cell may be performed based on the QCL information in an event that the SCell configuration does not include a reference cell indicator.

In some implementations, process 500 may further involve processor 412 determining the timing reference and the AGC source for the first SCell based on the SSB of the second SCell, and receiving, via transceiver 416, a TRS from the first SCell based on the timing reference and the AGC source. Additionally, process 500 may further involve processor 412 performing, via transceiver 416, a data transmission or reception to or from the first SCell based on the TRS.

In some implementations, the first SCell may be an inter-band SSB-less SCell.

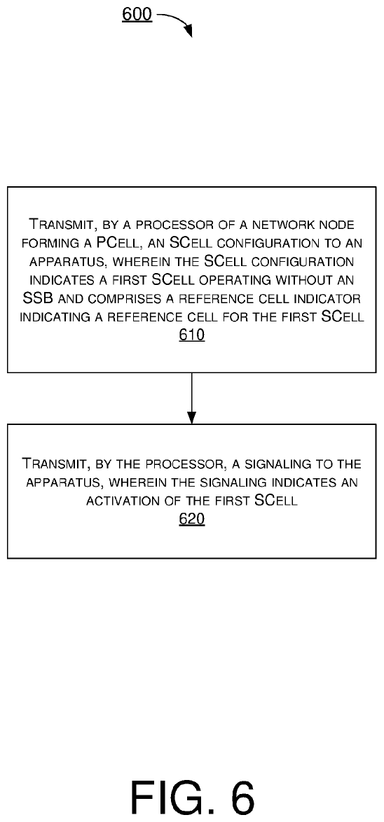

FIG. 6 illustrates an example process 600 in accordance with an implementation of the present disclosure. Process 600 may be an example implementation of above scenarios/schemes, whether partially or completely, with respect to SSB-less SCell operations in mobile communications. Process 600 may represent an aspect of implementation of features of network apparatus 420. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in network apparatus 420 or any suitable network node. Solely for illustrative purposes and without limitation, process 600 is described below in the context of communication apparatus 410, as a UE, and network apparatus 420, as a network node forming a PCell. Process 600 may begin at block 610.

At block 610, process 600 may involve processor 422 of network node apparatus 420 transmitting, via transceiver 426, an SCell configuration to communication apparatus 410, wherein the SCell configuration indicates a first SCell operating without an SSB, and the SCell configuration comprises a reference cell indicator indicating a reference cell for the first SCell. Process 600 may proceed from block 610 to block 620.

At block 620, process 600 may involve processor 422 transmitting, via transceiver 426, a signaling to communication apparatus 410, wherein the signaling indicates an activation of the first SCell.

In some implementations, the reference cell may include the PCell, a PSCell, or a second SCell, wherein the PSCell and the second SCell are activated.

In some implementations, the first SCell and the second SCell may be configured in a same TAG.

In some implementations, the first SCell may be an inter-band SSB-less SCell.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a secondary cell (SCell) configuration from a primary cell (PCell), wherein the SCell configuration indicates a first SCell operating without a synchronization signal block (SSB);
receiving, by the apparatus, a signaling from the PCell, wherein the signaling indicates an activation of the first SCell; and
determining, by the processor, a reference cell to provide a timing reference and an automatic gain control (AGC) source for the first SCell.

2. The method of claim 1, wherein the reference cell comprises the PCell, a primary secondary cell group (SCG) cell (PSCell), or a second SCell, and the PSCell and the second SCell are activated.

3. The method of claim 2, wherein the first SCell and the second SCell are configured in a same timing alignment group (TAG).

4. The method of claim 2, wherein the SCell configuration comprises quasi-colocation (QCL) information of a reference signal (RS) of the first SCell, and the QCL information indicates that the RS of the first SCell is QCLed with an SSB of the second SCell.

5. The method of claim 1, wherein the SCell configuration comprises a reference cell indicator, and the determining of the reference cell is performed based on the reference cell indicator.

6. The method of claim 4, wherein the determining of the reference cell is performed based on the QCL information in an event that the SCell configuration does not comprise a reference cell indicator.

7. The method of claim 4, further comprising:
determining, by the processor, the timing reference and the AGC source for the first SCell based on the SSB of the second SCell;
receiving, by the processor, a tracking reference signal (TRS) from the first SCell based on the timing reference and the AGC source; and
performing, by the processor, a data transmission or reception to or from the first SCell based on the TRS.

8. The method of claim 1, wherein the first SCell is an inter-band SSB-less SCell.

9. An apparatus, comprising:
a transceiver which, during operation, wirelessly communicates with a primary cell (PCell) and one or more secondary cells (SCells); and
a processor communicatively coupled to the transceiver such that, during operation, the processor performs operations comprising:
receiving, via the transceiver, an SCell configuration from the PCell, wherein the SCell configuration indicates a first SCell operating without a synchronization signal block (SSB);
receiving, via the transceiver, a signaling from the PCell, wherein the signaling indicates an activation of the first SCell; and
determining a reference cell to provide a timing reference and an automatic gain control (AGC) source for the first SCell.

10. The apparatus of claim 9, wherein the reference cell comprises the PCell, a primary secondary cell group (SCG) cell (PSCell), or a second SCell, and the PSCell and the second SCell are activated.

11. The apparatus of claim 10, wherein the first SCell and the second SCell are configured in a same timing alignment group (TAG).

12. The apparatus of claim 10, wherein the SCell configuration comprises quasi-colocation (QCL) information of a reference signal (RS) of the first SCell, and the QCL information indicates that the RS of the first SCell is QCLed with an SSB of the second SCell.

13. The apparatus of claim 9, wherein the SCell configuration comprises a reference cell indicator, and the determining of the reference cell is performed based on the reference cell indicator.

14. The apparatus of claim 12, wherein the determining of the reference cell is performed based on the QCL information in an event that the SCell configuration does not comprise a reference cell indicator.

15. The apparatus of claim 12, wherein, during operation, the processor further performs operations comprising:
determining the timing reference and the AGC source for the first SCell based on the SSB of the second SCell;
receiving, via the transceiver, a tracking reference signal (TRS) from the first SCell based on the timing reference and the AGC source; and
performing, via the transceiver, a data transmission or reception to or from the first SCell based on the TRS.

16. The apparatus of claim 9, wherein the first SCell is an inter-band SSB-less SCell.

17. A method, comprising:
transmitting, by a processor of a network node forming a primary cell (PCell), a secondary cell (SCell) configuration to an apparatus, wherein the SCell configuration indicates a first SCell operating without a synchronization signal block (SSB) and comprises a reference cell indicator indicating a reference cell for the first SCell; and
transmitting, by the processor, a signaling to the apparatus, wherein the signaling indicates an activation of the first SCell.

18. The method of claim 17, wherein the reference cell comprises the PCell, a primary secondary cell group (SCG) cell (PSCell), or a second SCell, and the PSCell and the second SCell are activated.

19. The method of claim 18, wherein the first SCell and the second SCell are configured in a same timing alignment group (TAG).

20. The method of claim 17, wherein the first SCell is an inter-band SSB-less SCell.
